(19) United States
(12) Patent Application Publication
(10) Pub. No.: US 2005/0149738 A1
(43) Pub. Date: Jul. 7, 2005

(54) Biometric authentication system and method for providing access to a KVM system

(76) Inventor: David G. Targosky, Streetsboro, OH (US)

Correspondence Address: Renner, Otto, Boisselle & Sklar, 19th Floor, 1621 Euclid Ave., Cleveland, OH, 44115, US

(21) Appl. No.: 10/750,936

(22) Filed: Jan. 2, 2004

(51) Int. Cl. H04L 9/32; G06F 12/14

(52) U.S. Cl. 713/182; 713/202

(57) ABSTRACT

The present invention relates to a system and method for providing a user access to at least one host computer through a Keyboard, Video, and Mouse (KVM) switch based upon biometric authentication of the user. In one embodiment, a method is provided for permitting a user to access a KVM switch based upon biometric data associated with a user in a single user station environment and a multiple user environment. In another embodiment, a system is provided for permitting a user to access a KVM system in a single and/or multiple user environment based upon biometric data associated with the user. The system further provides for direct coupling of host computers to the KVM switch and/or utilizing host adapters to couple a host computer to an input station. The system is scalable by communicatively coupling a fabric which may include associations with host computers or additional fabrics to the host adapters in order to provide a user a logical connection to a wide assortment of host computers.

### TECHNICAL FIELD

The present invention relates generally to a system and method for providing a user access to a Keyboard, Video, Mouse (KVM) system based upon biometric authentication of the user, and more particularly, to a system and method for providing access to at least one host computer associated with a KVM system based, at least in part, on the user's unique biometric data.

### BACKGROUND

A KVM switch represents a class of switching devices designed to provide a user the ability to operate, control, and monitor multiple computers from a single keyboard, monitor, and mouse. A system incorporating a KVM switch (a KVM system) allows the user to select a host computer to operate, monitor and control from the user's input station, terminal or workstation. The user may select the host computer from an interface displayed on the user's monitor or from controls located directly on the KVM switch. Generally, a KVM system works by allowing a user to select a host computer to monitor and control from the terminal or workstation accessible to the user. The KVM system may be located locally to the user or the user may gain access to the KVM system remotely. A KVM system is generally capable of switching the video signals of the selected host computer to the user's monitor so that the user may view the host's video signal from the user's monitor. A KVM system is also capable of routing the user's keyboard and mouse signals to the respective ports of the selected host computer. From the host computer's perspective, it appears as if the user's keyboard and mouse are directly attached to the host.

Users of KVM systems include system administrators, developers, software or hardware engineers, technicians, graphic artists, etc. Examples of tasks that are commonly performed with KVM systems include monitoring applications that are running on the host computers, installing or upgrading software applications or programs, and re-booting the host computers. KVM systems are commonly used by Internet Service Providers (ISPs). ISPs require a large number of computers to handle the large volume of Internet traffic and data. ISPs use KVM systems to provide centralized oversight, thereby reducing the burden of computer maintenance and administration.

In addition, KVM systems are used in distributed processing where applications are executed using the processing power of a number of interconnected computers. For example, it is becoming increasingly popular to use computer generated images for animation and special effects in movies. Computer graphics of this kind entail a large amount of intensive calculations and often require more processing power than is available from any one computer standing alone. In order to enhance processing power and speed, tasks are distributed over a number of host computers. KVM systems allow for control and monitoring of these computers from a single workstation or terminal.

The benefits provided by KVM systems include the time saved by eliminating the need to travel from host to host to operate, monitor or control each host computer. In addition, the keyboards, monitors and mice of the host computers are no longer needed and can be eliminated, thereby saving money and space.

Access to KVM systems typically requires a user to enter unique user identification (user ID) or user name and a password that is usually input from a keyboard associated with the terminal in which the user attempts to gain access to the KVM system. There are many shortcomings associated with this method of user authentication. For example, a user may voluntarily provide their user ID and password to others without detection from the system administrator. A user may also provide their user ID and password to others involuntarily by a third party eavesdropping on the user as he or she enters their user ID and password through a keyboard or a camera could be covertly installed to view a user as he or she types the their user ID and password into the keyboard. These security breaches can lead to unauthorized use of the KVM system, thereby allowing unauthorized users access to potentially confidential and sensitive information.

The computer industry has recognized a growing need for sophisticated security systems for computer and computer networks. Biometric authentication is one such method. Biometrics is the measurement of quantifiable biological traits. Certain biological traits, such as the unique characteristics of each person's fingerprint, have been measured and compared and found to be unique or substantially unique for each person. These traits are referred to as biometric markers. The computer industry is developing identification and authentication systems that measure and compare certain biometric markers in order to use the markers as biological keys or passwords which can be used to authenticate a user in the same manner that conventional user ID's and passwords are presently entered from a keyboard.

Due to the confidential and sensitive information typically associated with a KVM system and the potential for unauthorized users to gain access to such information, there is a strong need in the art for providing access to a KVM system based upon biometric data associated with an authorized user of the KVM system.

### SUMMARY OF THE INVENTION

The present invention is directed to a system and method for providing a user access to a KVM system including multiple host computers upon successful biometric authentication.

One aspect of the present invention relates to a system for permitting a user to access a KVM system based upon biometric data associated with the user, the system including: a KVM switch; at least one user station communicatively coupled to the KVM switch, wherein the user station includes at least one user input device; at least one host computer communicatively coupled to the KVM switch; an authentication device communicatively coupled to the KVM switch and to an identification input device, wherein the authentication device is capable of providing an associated user access to the KVM switch based at least in part upon information received from the identification input device; and the identification input device is capable of receiving biometric data associated with the user seeking access to the KVM switch from the user station.

Another aspect of the present invention relates to a method for permitting a user to access a KVM switch based upon biometric data associated with a user, the method including: requesting biometric data associated with a user in response to a user request for access to a KVM switch; receiving the biometric data associated with the user of the user station; authenticating the biometric data associated with the user of the user station; providing the user access to a device associated with the KVM switch.

Another aspect of the present invention relates to a system for permitting a user access to a KVM system based upon biometric data associated with the user, the system including: an input station including at least one user input device; the input station communicatively coupled to an authentication device; an identification input device communicatively coupled to the authentication device, wherein the identification input device is capable of generating biometric data associated with a user of the input station; and the input station communicatively coupled to a host adapter for providing an associated user of the input station access to the at least one host computer based at least in part upon a portion of the biometric data received from the identification input device.

Another aspect of the present invention relates to a system for permitting a user access to a KVM system based upon biometric data associated with the user, the system including: at least one input station including at least one user input device; an authentication device communicatively coupled to the at least one input station; an identification input device communicatively coupled to the authentication device, wherein the identification input device is capable of generating biometric data associated with a user of the at least one input station; and the at least one user input station communicatively coupled to a host adapter for providing an associated user of the at least one input station access to at least one host computer based at least in part upon a portion of the biometric data received from the identification input device.

Another aspect of the present invention relates to a system for permitting a user to access a KVM system based upon biometric data associated with the user, the system including: at least one input station including at least one input device; an authentication device communicatively coupled to the at least one input station; an identification input device communicatively coupled to the authentication device, wherein the identification input device is capable of generating biometric data associated with a user of the at least one input station; and the input station communicatively coupled to a host adapter for providing an associated user of the user station access to a device associated with the host adapter based at least in part upon a portion of the biometric data received from the identification input device.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1A-1C illustrate exemplary single user topologies in accordance with the present invention;

FIG. 2 is an exemplary system in accordance with the present invention.

FIG. 3 is an exemplary multiple user topology in accordance with the present invention;

FIG. 4 illustrates an exemplary single user topology in accordance with the present invention; and

FIG. 5 illustrates an exemplary multiple user topology in accordance with the present invention.

### DETAILED DESCRIPTION OF THE INVENTION

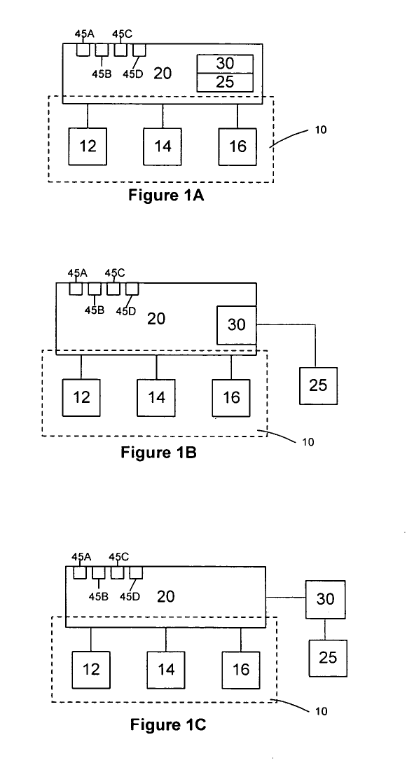

The following description is exemplary in nature and is in no way intended to limit the scope of the invention as defined by the claims appended hereto. Referring to FIG. 1A, an exemplary integrated user station 10 and KVM switch 20 is shown. As used herein, the term “user station” refers to devices that connect to the KVM switch 20 and the associated interface. Referring to FIG. 1A, the user station 10 includes a keyboard 12, a computer monitor 14, and a mouse 16. FIG. 1A also illustrates an identification input device 25 and an authentication module 30 integrated into the KVM switch 20. The KVM switch 20 further includes interfaces 45A-45D which allows the user station 10 to make a logical connection to at least one host computer (not shown), depending on the user's access rights.

The user station 10 generally includes at least one user input device. As shown in FIG. 1A, suitable input devices include a keyboard 12 and a mouse 18. As used herein, the term “keyboard” includes any conventional computer keyboard as well as any keypad entry device. Likewise, the term “mouse” includes any conventional computer mouse, a trackball, a thumbwheel, etc. In certain limited circumstances, a computer monitor 14 may also be referred to as a user input device (e.g., when the computer monitor is a touch screen device).

In the single user environment, the identification input device 25 is typically located geographically (or logistically) near the user station 10 and is communicatively coupled to the KVM switch 20. As used herein, the phrase “communicatively coupled” should be interpreted in broadest terms to include a direct physical connection, an indirect connection and any logical connection. The identification input device 25 of the present invention makes use of biometric markers of the user. Biometric markers presently used by the industry for authentication and identification include measurements of unique visible features such as fingerprints, hand and face geometry, and retinal and iris patterns, as well as the measurement of unique behavioral responses such as the recognition of vocal patterns and the analysis of hand movements. The use of each of these biometric markers requires a device to make the biological measurement and process it in electronic form. The device may measure and compare the unique spacing of the features of a person's face or hand and compare the measured value with a value stored in memory or an electronic storage component (e.g., disk drive) associated with the device. Where the measured values match the stored values, the person is identified or authorized.

Several types of technologies are used in biometric identification of superficial anatomical traits. For example, biometric fingerprint identification systems may require the individual being identified to place his or her finger on a visual scanner. The scanner reflects light off of the person's finger and records the way the light is reflected off of the ridges that make up the fingerprint. Hand and face identification systems use scanners or cameras to detect the relative anatomical structure and geometry of the person's face or hand. Different technologies are used for biometric authentication using the person's eye. For retinal scans, a person will place his or her eye close to or upon a retinal scanning device. The scanning device will scan the retina to form an electronic version of the unique blood vessel pattern in the retina. An iris scan records the unique contrasting patterns of a person's iris.

Still other types of technologies are used for biometric identification of behavioral traits. Voice recognition systems generally use a telephone or microphone to record the voice pattern of the user received. Usually the user will repeat a standard phrase, and the device compares the measured voice pattern to a voice pattern stored in the system. Signature authentication is a more sophisticated approach to the universal use of signatures as authentication. Biometric signature verification not only makes a record of the pattern of the contact between the writing utensil and the recording device, but also measures and records speed and pressure applied in the process of writing.

The identification input device 25 is communicatively coupled to an authentication module 30. The authentication module 30 provides a mechanism for the biometric information received from the identification input device 25 to be linked to or identify an authorized user of the system. The authentication module 30 may include a self-contained electronic storage that includes a database of biometric information associated with authorized users. Likewise, the authentication module 30 may be linked to a server which contains an electronic database of biometric information associated with an authorized user. In general, the authentication module 30 receives biometric data from a potential user of the system and determines if the user seeking access to the system is authorized to access the KVM system. If the biometric information received at the authentication module 30 matches, at least a portion of the data associated with an authorized user, the authentication module 30 allows the user to access the KVM system, depending upon the administrative rights or privileges provided the user from the system administrator.

As shown in FIG. 1A, the identification input device 25 and the authentication module 30 is shown integrated into the KVM switch 20. FIG. 1B illustrates the authentication module 30 integrated into the KVM switch 20 and the identification input device 25 being communicatively coupled to the authentication module 30, which is integrated into the KVM switch 20. FIG. 1C further illustrates an embodiment wherein the identification input device 25 and the authentication module 30 are distinct from the KVM switch 20. One of ordinary skill in the art will readily appreciate that the identification input device 25 and/or authentication module 30 may be in any combination of the above illustrated embodiments (e.g., the identification input device 25 may be integral to the KVM switch 20, but the authentication may be distinct). The precise configuration of the authentication module 30 and the identification input device 25 is immaterial, provided the configuration provides the functionality described herein.

The integrated single-user user station 10 and KVM switch 20 having an identification input device 25 and an authentication module 30 integrated into or communicatively coupled to the KVM switch 25, as illustrated in FIGS. 1A-1C, are referred herein as being dedicated, (i.e., a dedicated identification input device 25 and authentication module 30 may only provide access from the user station 10 which is connected to the same KVM switch 20 that the identification input device 25 and authentication module 30 are connected).

In many situations it may be advantageous to include a dedicated identification input device 25 and authentication module 30 for each user station 10 associated with the KVM switch 20. For example, when the number of user stations is relatively small and when the user stations are widely geographically dispersed or when additional security is deemed appropriate. However, there may also be advantages in having at least one of the identification input device 20, authentication module 30 and KVM switch 25 centrally located to multiple user stations.

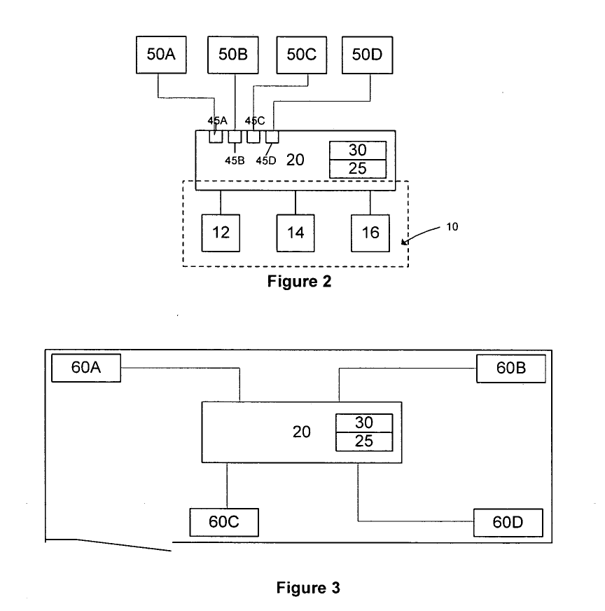

FIG. 2 illustrates the host computers 50A-50D communicatively coupled to the KVM switch 20. Host computers 50A-50D may take a variety of forms, including: a personal or laptop computer running a Microsoft Windows operating system, a PalmOS operating system, a UNIX operating system, a Linux operating system, a Solaris operating system, an OS/2 operating system, a BeOS operating system, a MacOS operating system, a VAX VMS operating system, or other operating system or platform. Host computers 50A-50D may further include a microprocessor such as an Intel x86-based or Advanced Micro Devices x86-compatible device, a Motorola 68K or PowerPC device, a MIPS device, Hewlett-Packard Precision device, or a Digital Equipment Corp Alpha RISC processor, a microcontroller or other general or special purpose device operating under programmed control. Likewise, host computers 50A-50D may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons of ordinary skill in the art.

Referring to FIG. 3, an exemplary multi-user system is shown in accordance with the present invention. KVM switch 20, identification input device 25, and authentication module 30 are shown centrally located in an office or workspace with multiple user stations (60A-60D) dispersed throughout. In this topology, user stations 60A-60D typically include a keyboard, a computer monitor, and a mouse. A primary advantage associated with this topology is the cost savings associated with the sharing of common components amongst several user stations 60A-60D. Thus, instead of purchasing four distinct identification input devices 25 (as shown in FIGS. 1A-1C), one identification input device 25 may be used to service all of the user stations (60A-60D). Likewise, instead of purchasing four KVM switches 20 and authentication modules 30, only one KVM switch 20 (having a sufficient number of ports) is required to serve multiple user stations 60A-60D.

With the centralized topology shown in FIG. 3, there is a need for an authentication protocol whereby a user requests access to a user station 60 and is prompted by the computer monitor associated with the workstation or another means to present him or herself at the identification input device 25 to enter biometric data. For example, when a user requests access from the workstation 60A, a computer monitor associated with workstation 60A may prompt the user to present himself or herself to the identification input device 25 in order to input biometric data associated with the user for authentication. The identification input device 25 receives the biometric data and transmits at least a portion of the received data to the authentication module 30. If the authentication module 30 determines that the user is authorized to use the KVM system, the user is properly authenticated and permitted to access the KVM system, depending upon the user's access rights or privileges determined by the system administrator. In another example, the user may be required to be biometrically authenticated prior to gaining access to a room in which a workstation 60 is present. Upon entering the secured room, an administrator will assign the user the appropriate workstation in which to use. One of ordinary skill in the art will readily appreciate that there are numerous ways in which to prompt a user to present himself or herself for authentication at a user identification device 25 in a multi-user environment.

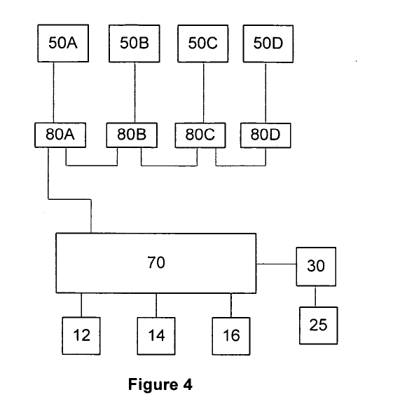

FIG. 4 depicts another embodiment of the present invention. An input station 70 enables the relocation of a PS/2 or USB keyboard 12, a computer monitor 14, and mouse 16 to multiple host computers 50. An identification input device 25 and an authentication module 30 is further communicatively coupled to the input station 70. As explained above, the user identification module 25 and the authentication module 30 may or may not be integrated into the input station 70. The identification input device 25 receives the biometric data associated with a user seeking access to the input station 70 or an associated host computer 50. The identification input device 25 transmits at least a portion of the received data to the authentication module 30. If the authentication module 30 determines that the user is authorized to use the KVM system, the user is properly authenticated and permitted to access the KVM system based upon the user's access rights or privileges determined by the system administrator. For example, a user may be permitted access to certain host computers (e.g., 50A and 50B which may contain the mail and application servers), but not permitted access to other host computers (which may contain confidential financial or accounting information).

The host adapter 80 communicatively couples the input station 70 to at least one host computer 50, assuming the user has access rights to at least one host computer 50. The host adapter 80 and the user station 70 are interconnected with a cable medium (e.g., CAT5 unshielded twisted pair or shielded twisted pair cable, CAT5e cable, or CAT6 cable). In the single-user topology, as shown in FIG. 4, the present invention permits the user to access a maximum of 64 host computers (assuming the user has been granted the appropriate administrative rights). One of ordinary skill in the art will readily appreciate that the maximum number of host computers is not a limitation of the current invention and so long as the user is able to access at least one host computer 50, a system falls within the scope of the present invention.

The input station 70 can be used with a variety of input devices, containing various interface connectors. In particular, the input station 70 accepts PS/2 devices having a 6 pin miniDIN female connectors and USB devices for use with a mouse and/or keyboard. Likewise, the input station 70 includes a 15HD male video connector for receiving a standard computer monitor connector (a 15HD female video connector). One of ordinary skill in the art will readily appreciate that the input station 70 may be designed to accept a multitude of input devices having a variety of connectors and interfaces and fall within the scope of the present invention.

The host adapter 80 includes an interface for connecting a host computer 50 to the input station 70. The input station 70 receives input from the keyboard 12 or the mouse 16, terminates the information, normalizes the information (depending on the type of device interface) and stores and forwards the information to the destination host computer. The information is output from the input station 70 to the host adapter 80 via a cable medium. In one embodiment, the input station 70 includes an RJ45 female for receiving a cable medium. The output of the input station 70 is input to the output port of the host adapter 80. The host adapter 80 is also connected to at least one host computer 50. In one embodiment, a separate host adapter 80 is needed for every host computer 50 added to the KVM system. The host adapter 80 connects to the host computer through standard component connectors. For instance, depending on the ports of the host computer, appropriate connectors would be PS/2 or USB for a mouse and/or keyboard. A standard video connector is also provided (e.g., 15HD male) for displaying video from the host computer 50 on the computer display 14 associated with the input station 70.

As stated above, additional host computers 50 may be added to a particular system. An additional interface connection is provided on the host adapter 80 which permits daisy-chaining of host adapters in order to provide a user access to more than one host computer. As shown in FIG. 4, one or more additional host computers 50B-50D are added to the system by including a cable medium between the output port of the newly added host adapter 80B-80D and the input port of the previously existing host adapter. In this manner, the host adapters are daisy-chained to provide the user with access with each host computer in the system, depending upon network administration privileges.

The scalability described herein requires the host adapter 80 to be identified by a unique identification number. For example, the host adapter 80 may be assigned a logical number based upon the number of host adapters included in the system or the host adapter may be assigned its serial number as its unique identifier. When a new host is discovered, the user interacting with the switch may have the ability to access the new host, assuming the network administrator allows the user access to the new host computer.

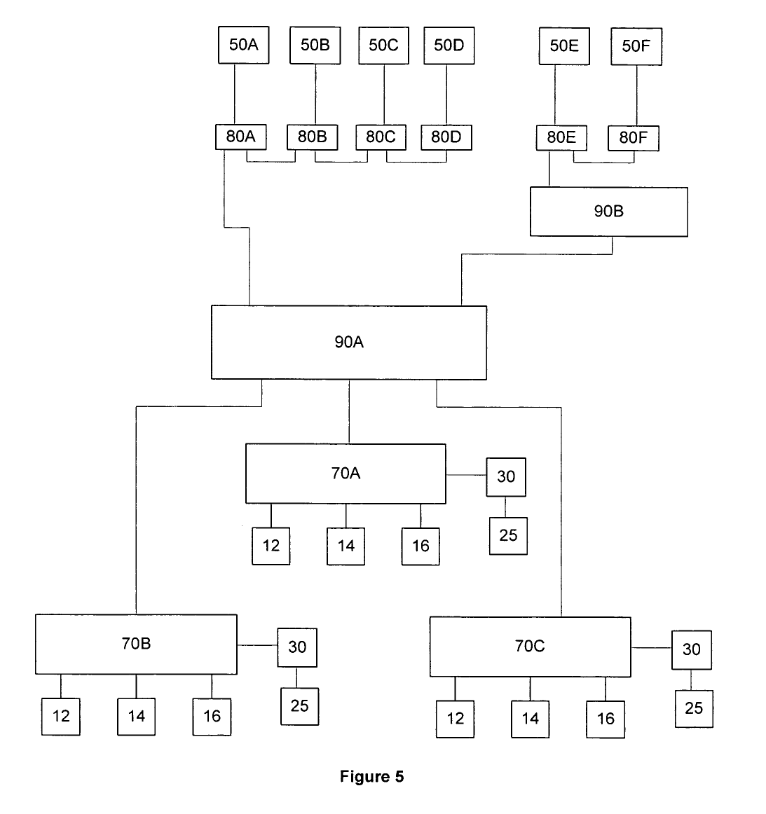

A multiple user topology associated with the present invention is shown in FIG. 5. The functionality of the keyboard 12, computer monitor 14, mouse 16, identification input device 25 and authentication module 30 associated with the user stations 70A-70C is identical to that disclosed above. Prior to a user gaining access to the fabric 90A or a host computer associated therewith, the user must be biometrically authenticated. Instead of the user stations 70A-70C being directly connected to the host adapter 80, as shown in FIG. 4, the user stations 70A-70C are coupled to a fabric 90A. The fabric 90A permits one or more user stations (70A-70C) to connect to the host computers (50A-50D) in the same fashion as a single user system, as discussed above. In addition to host computers (50A-50D) communicatively coupled to the fabric 90A via host adapters (80A-80D), the fabric 90A may be communicatively coupled to additional fabrics 90B which may be communicatively coupled to host computers (50E-50F) and/or additional fabrics (not shown).

As one of ordinary skill in the art will readily appreciate, the process of authentication may vary for the present invention depending on the precise topology employed. While various aspects of the invention were illustrated in FIGS. 1-5, one of ordinary skill in the art should appreciate that the topologies discussed above may be modified and/or combined. Regardless of the exact topology employed, the authentication process is substantially the same. The authentication module 30 receives at least a portion of the biometric data detected by the identification input device 25 and determines based upon stored biometric parameters associated with authorized user whether to authenticate the prospective user. Upon proper authentication, the user will have access to the KVM system, the input station 70 or the fabric 90A (depending upon the topology of the system) and to all or a limited number of the host computers 50A-50F based upon the user's network privileges determined by the network administrator. In one embodiment, upon proper authentication, the user will be connected to a predetermined host computer upon authentication based upon the host computer most frequently utilized by user and/or last visited by the user. In another embodiment, the user will be prompted to identify the host computer he or she seeks access when the user presents himself or herself to the identification input device 25. If the user is unable to be properly authenticated, the present invention prevents the authorized user from accessing the fabric or host computers associated with the KVM switch 20 (and/or the input station 70). One of ordinary skill in the art will readily appreciate that there are a variety of ways for a user to identify which host computer the user seeks to access (e.g., a software interface may be used to implement a selection mechanism or a hardware interface, such as a push button located on the KVM switch, may be similarly be used. Likewise, a user that is unable to be properly authenticated may be provided access to an un-secure host computer or alternatives that the network administrator may be appropriate.

When transmitting biometric data between the identification input device 25 and the authentication module 30, the biometric data may or may not be encrypted depending on the security policy of the network administrator. Likewise, information received and transmitted between the host computers 50A-50F and user stations (10A-10D, 60A-60D or 70A-70C) may or may not be encrypted. Sensitive information (e.g., biometric log-in information and confidential data input by the user or stored on host computers 50A-50F) may be encrypted using any encryption algorithm (e.g., SSH, PGP, DES, or 3DES) to prevent unauthorized users from having access to the confidential information.

It should be readily apparent to those of ordinary skill in the art that the particular interface between the authentication module 30 and the system described herein can take many forms and can be written and implemented by someone of ordinary skill in art. For instance, the interface can be written in computer code and stored, in whole or in part, on in the authentication module 30, the KVM switch 20, the user stations (10A-10D, 60A-60D or 70A-70C), the identification input device, or any other device which the developer deems appropriate.

Access to the host computers in this embodiment and/or in the other embodiments described herein may expire when a user logs off or when user station and/or input device associated with the user station indicates that there has not been user activity associated with a given user station for a predetermined period of time. Once a session has expired, a user is required to re-authenticate himself or herself in order to regain access to the KVM system. In addition, a user may be restricted access to system based on the time of day. For instance, a user may only be given access to a given host computer during normal business hours.

It should be appreciated that the above described system and methods provide for users to be authenticated using unique biometric data in order to gain access to at least one host computer associated with a KVM system. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A system for permitting a user to access a KVM system based upon biometric data associated with the user, the system comprising:
a KVM switch;
at least one user station communicatively coupled to the KVM switch, wherein the user station includes at least one user input device;
at least one host computer communicatively coupled to the KVM switch;
an authentication device communicatively coupled to the KVM switch and to an identification input device, wherein the authentication device is capable of providing an associated user access to the KVM switch based at least in part upon information received from the identification input device; and
the identification input device is capable of receiving biometric data associated with the user seeking access to the KVM switch from the user station.

2. The system of claim 1, wherein the user input device includes at least one of a keyboard or mouse.

3. The system of claim 1, wherein the identification input device is integral to the KVM switch.

4. The system of claim 3, wherein the authentication device is integral to the KVM switch.

5. The system of claim 1, wherein the authentication device is integral to the KVM switch.

6. The system of claim 1, wherein the biometric data is obtained from at least one of a fingerprint scan of the user, a retinal scan of the user, a sampling of the user's DNA, a sampling of the user's voice, a sampling of the user's breath, or a sampling of the user's signature.

7. The system of claim 1, wherein the authentication device further includes a set of reference data for associating the user with a set of unique biometric data.

8. The system of claim 1, wherein the KVM switch provides the user access to a predetermined host computer upon proper authentication.

10. A method for permitting a user to access a KVM switch based upon biometric data associated with a user, the method comprising:
requesting biometric data associated with a user in response to a user request for access to a KVM switch;
receiving the biometric data associated with the user of the user station;
authenticating the biometric data associated with the user of the user station;
providing the user access to a device associated with the KVM switch.

11. The method of claim 10, wherein the user is provided access to the KVM switch from the user station wherein the request for access to the host computer originated.

12. The method of claim 10 further including determining the user's access rights to the device associated with the KVM switch.

13. The method of claim 10 wherein the biometric data is obtained from at least one of a fingerprint scan of the user, a retinal scan of the user, a sampling of the user's DNA, a sampling of the user's voice, a sampling of the user's breath, or a sampling of the user's signature.

14. The method of claim 10 wherein the biometric data includes a unique set of information pertaining to authorized users of the KVM switch.

15. The method of claim 10 wherein the device associated with the KVM switch is a host computer.

16. A system for permitting a user access to a KVM system based upon biometric data associated with the user, the system comprising:
an input station including at least one user input device;
the input station communicatively coupled to an authentication device;
an identification input device communicatively coupled to the authentication device, wherein the identification input device is capable of generating biometric data associated with a user of the input station; and
the input station communicatively coupled to a host adapter for providing an associated user of the input station access to the at least one host computer based at least in part upon a portion of the biometric data received from the identification input device.

17. The system of claim 16 wherein the user input device includes at least one of a keyboard or mouse.

18. The system of claim 16 wherein the identification input device is directly coupled to the input station.

19. The system of claim 16 wherein the identification input device is integral to the input station.

20. The system of claim 19 wherein the authentication module is integral to the KVM switch.

21. The system of claim 16 wherein the authentication module is integral to the KVM switch.

22. The system of claim 16 wherein the at least a portion of the biometric data includes a substantially unique set of data from a user including at least one of a fingerprint scan of the user, a retinal scan of the user, a sampling of the user's DNA, a sampling of the user's voice, a sampling of the user's breath, or a sampling of the user's signature.

23. The system of claim 16 wherein the authentication device further includes a set of reference data for associating the user with a set of unique biometric data.

24. The system of claim 16 wherein the host adapter logically couples the associated user to a predetermined host computer.

25. The system of claim 24 wherein the host adapter includes a unique logical address.

26. The system of claim 16, wherein the host computers are interfaced together through the host adapter associated with the host computer.

27. The system of claim 26, wherein the host adapter associated with one host computer is linked to the host adapter associated with another host computer through a daisy-chain connection.

28. A system for permitting a user access to a KVM system based upon biometric data associated with the user, the system comprising:
at least one input station including at least one user input device;
an authentication device communicatively coupled to the at least one input station;
an identification input device communicatively coupled to the authentication device, wherein the identification input device is capable of generating biometric data associated with a user of the at least one input station; and
the at least one input station communicatively coupled to a host adapter for providing an associated user of the at least one input station access to at least one host computer based at least in part upon a portion of the biometric data received from the identification input device.

29. The system of claim 28 wherein the user input device includes at least one of a keyboard or mouse.

30. The system of claim 28 wherein the user identification device is integral to the input station.

30. The system of claim 29 wherein the authentication module is integral to the input station.

31. The system of claim 28 wherein the authentication module is integral to the input station.

32. The system of claim 28 wherein the biometric data includes a substantially unique set of data from a user including at least one of a fingerprint scan of the user, a retinal scan of the user, a sampling of the user's DNA, a sampling of the user's voice, a sampling of the user's breath, or a sampling of the user's signature.

33. The system of claim 28 wherein a fabric logically couples the at least input station to the host adapter associated with the at least one host computer.

34. The system of claim 28, wherein the host computers are interfaced together through the host adapter associated with the associated host computer.

35. The system of claim 28, wherein the host adapters are linked together though a daisy-chain connection.

36. A system for permitting a user to access a KVM system based upon biometric data associated with the user, the system comprising:
at least one input station including at least one input device;
an authentication device communicatively coupled to the at least one input station;
an identification input device communicatively coupled to the authentication device, wherein the identification input device is capable of generating biometric data associated with a user of the at least one input station; and
the input station communicatively coupled to a host adapter for providing an associated user of the user station access to a device associated with the host adapter based at least in part upon a portion of the biometric data received from the identification input device.

37. The system of claim 36 wherein the user input device includes at least one of a keyboard or mouse.

38. The system of claim 36 wherein the user identification device is integral to the input station.

39. The system of claim 38 wherein the authentication module is integral to the input station.

40. The system of claim 36 wherein the authentication module is integral to the input station.

41. The system of claim 36 wherein the biometric data includes a substantially unique set of data from a user including at least one of a fingerprint scan of the user, a retinal scan of the user, a sampling of the user's DNA, a sampling of the user's voice, a sampling of the user's breath, or a sampling of the user's signature.

42. The system of claim 36 wherein the device is a host computer.

43. The system of claim 36 wherein the host adapter logically couples the input station to a predetermined host computer.

44. The system of claim 43 wherein the host adapter includes a unique logical address.

45. The system of claim 36, wherein the plurality of host computers are interfaced together through the host adapters associated with each of the plurality of host computers.

46. The system of claim 45, wherein the host adapters are linked to the plurality of input stations though a daisy-chain connection.
